(19) United States
(12) Patent Application Publication
(10) Pub. No.: US 2014/0379911 A1
(43) Pub. Date: Dec. 25, 2014

(54) Network Activity Association System and Method

(71) Applicant: GFI Software IP S.a.r.l., Luxembourg (LU)

(72) Inventors: Samer Nabih Fayssal, Dunedin, FL (US); Sergio Galindo, Millstone Township, NJ (US)

(73) Assignee: GFI Software IP S.a.r.l., Luxembourg (LU)

(21) Appl. No.: 13/923,786

(22) Filed: Jun. 21, 2013

(51) Int. Cl. H04L 29/08

(52) U.S. Cl. CPC H04L 67/306
USPC 709/225

(57) ABSTRACT

A method is provided for associating a networking device with a profile by analyzing a usage pattern of communicating over one or more network and comparing the usage pattern with a benchmark pattern of the profile. The method may authenticate the networking device that correlates with a profile within a threshold level of confidence. The method may identify the networking device using an address, such as a MAC address. The method may detect and analyze application usage for authentication. A system is provided for authenticating a networking device in accordance with the method.

### FIELD OF THE INVENTION

The invention relates to wireless networks. More particularly, the invention relates to associating a profile with a wireless networking device for authentication.

### BACKGROUND

Modern computing involves communication among electronic devices. This communication may occur over a network, which may include a collection of computers and other electronic hardware interconnected by communication channels. Many homes and offices have a number of computers connected via a local area network (LAN). Computers may be networked in the LAN via a wired or wireless connection. A wireless local area network (WLAN) is established using a device known as wireless router. The wireless router mostly provides local area network access to wirelessly connect client devices such as notebook/laptop computers, smart phones, tablets, and other portable computer devices.

A computerized networking device typically connects to a network using a network interface controller. To connect to a wireless network, a client device typically uses a wireless network interface controller. The wireless network interface controller may use a driver to receive instructions and operate within an operating system, which is software that manages the computer hardware, for example, Windows, Unix, Linux, and Apple Macintosh OS.

A wireless network interface controller and its driver follow a communication protocol to connect to the wireless router. Typically, the communication protocol is adherent to the IEEE 802.11 standard, which is created by the Institute for Electrical and Electronic Engineers to facilitate communication between various wireless devices. The communication protocol establishes rules and standards to allow multiple networking devices to communicate with one another.

The router, which may be a wired, wireless, and/or optical networking device, bridges a connection between a LAN and a wide area network (WAN). An example of a WAN is the Internet. Typically, a WAN uses an Internet Protocol (IP) address to identify networks. A LAN typically uses Medium Access Control (MAC) addresses to identify devices.

The wireless network interface controller may transmit and receive bits of data as defined by the IEEE 802.11 standard. A MAC address may be used and analyzed to determine whether a packet of data is intended for a particular wireless network interface controller. If the wireless network interface controller does not have the MAC address that corresponds to the broadcast communication, the contents of that communication may be disregarded.

An end-to-end connection can be established over the Internet between devices operating at different locations across a WAN to provide virtually seamless communication. However, with the current state of the art, a user connected to and communicating with another user across a WAN cannot see the hardware address of the other connected device. Therefore, the user is disadvantaged by not being able to authenticate the device with which he or she is communicating, undesirably exposing the user to risks associated with unauthorized access to the user's networking device.

The failure to authenticate a device under the present state of the art can subject network connected data communications to be abused by hackers, spammers, and other nefarious Internet users. Since users cannot be differentiated from one another on a remote LAN, anonymously connected users may gain access to data communication or devices communicating data. Due to this shortcoming in the present state of the art, WLANs have become a safe haven for network crackers to launch cyber-attacks over the Internet, costing the world economy billions every year.

What is needed is a system and method to identify a computerized networking device that is attempting to connect to a network. What is needed is a system and method to associate one or more networking device to a profile for authentication. What is needed is a system and method that can allow and at least partially deny access to a network with respect to authentication with a threshold level of confidence.

### SUMMARY

According to embodiments of the present invention, a system and method is provided that can identify a computerized networking device that is attempting to connect to a network. According to an embodiment of the present invention, a system and method is provided that can associate one or more networking device to a profile for authentication. According to an embodiment of the present invention, a system and method is provided that can allow and at least partially deny access to a network with respect to authentication with a threshold level of confidence.

In one aspect, a network activity association method operated on a computerized device with a processor and memory is provided to authenticate connection of a networking device to a network. The method may include analyzing a network to detect an identifiable networking device. The method may also include identifying the networking device using an address. Additionally, the method may include associating the networking device with a profile. The method may include analyzing a usage pattern of communicating over the network for the profile to maintain a benchmark usage pattern. The method may further include analyzing a subsequent usage pattern of communicating over the network for the profile. After analyzing the usage patterns, the method may include comparing the subsequent usage pattern with the benchmark usage pattern to determine a correlation. The method may then include authenticating the profile with the correlation within a threshold level of confidence. The method may additionally include allowing access to the network for the profile that is authenticated and at least partially denying access to the network for the profile that fails to be authenticated. The profile may be indicative of a user. The benchmark usage pattern may be updatable. A plurality of networking devices is associable with the profile. The profile may be stored in a database accessible from the network. The profile is accessible from the database over a plurality of networks.

In another aspect of the method, the address may be a medium access control (MAC) address.

In another aspect of the method, the network may be associable with a wireless router.

In another aspect of the method, associating the networking device with a profile further includes determining a network address for the wireless router to be included in a first list, determine the address for the networking device to be included in a second list, comparing the first list with the second list to determine a connective relationship between the networking device and the wireless router, and associating connection labels comprising location and time with the connective relationship in the profile.

In another aspect of the method, the usage pattern may include information relating to execution of applications on the networking device.

In another aspect of the method, a first device and a second device that are commonly simultaneously connected to the network are associable with the profile and increase compliance of the correlation within the threshold level of confidence.

In another aspect of the method, upon detecting a connection to the network by the profile that is authenticated for an additional network, the system may include the additional network in the profile and update the correlation between the profile and the network.

In another aspect, the method further includes generating an alert for the profile that fails to be authenticated.

According to an embodiment of the present invention, a method aspect for associating networking devices with a profile operated on a computerized device with a processor and memory is provided. The method may include analyzing a network associable with a wireless router to detect an identifiable networking device and identifying the networking device using an address. The method may also include associating the networking device with a profile, further involving determining a network address for the wireless router to be included in a first list, determining the address for the networking device to be included in a second list, comparing the first list with the second list to determine a connective relationship between the networking device and the wireless router, and associating connection labels comprising location and time with the connective relationship in the profile. The method may additionally include analyzing a usage pattern of communicating over the network for the profile to maintain a benchmark usage pattern. The method may include analyzing a subsequent usage pattern of communicating over the network for the profile and comparing the subsequent usage pattern with the benchmark usage pattern to determine a correlation. The method may also include authenticating the profile with the correlation within a threshold level of confidence and allowing access to the network for the profile that is authenticated and at least partially denying access to the network for the profile that fails to be authenticated, an alert being generable for the profile that fails to be authenticated. The profile is indicative of a user. The benchmark usage pattern is updatable. A plurality of networking devices is associable with the profile.

In another aspect of the method, the address is a medium access control (MAC) address.

In another aspect of the method, the profile is storable in a database accessible from the network. Additionally, in this aspect, the profile is accessible from the database over a plurality of networks.

In another aspect of the method, the usage pattern may include information relating to execution of applications on the networking device.

In another aspect of the method, a first device and a second device that are commonly simultaneously connected to the network are associable with the profile and increase compliance of the correlation within the threshold level of confidence.

In another aspect of the method, upon detecting a connection by the profile that is authenticated to an additional network, the system may include the additional network in the profile and update the correlation between the profile and the network.

According to an embodiment of the present invention, a network activity association system is provided to associate networking devices with a profile and authenticate a connection. The system may include a processor and memory. The system may include an association module to detect an identifiable networking device by performing the steps of analyzing a network to detect the identifiable networking device, identifying the networking device using an address, and associating the networking device with a profile. The system may also include an authentication module to authenticate the profile by performing the steps of analyzing a usage pattern of communicating over the network for the profile to maintain a benchmark usage pattern, analyzing a subsequent usage pattern of communicating over the network for the profile, comparing the subsequent usage pattern with the benchmark usage pattern to determine a correlation, authenticating the profile with the correlation within a threshold level of confidence, and allowing access to the network for the profile that is authenticated and at least partially denying access to the network for the profile that fails to be authenticated, wherein an alert is generable for the profile that fails to be authenticated. The profile may be indicative of a user. The benchmark usage pattern is updatable. A plurality of networking devices is associable with the profile. The profile is storable in a database accessible from the network and the profile is accessible from the database over a plurality of networks. The network is associable with a wireless router.

In another aspect, the address is a medium access control (MAC) address.

In another aspect, associating the networking device with a profile may further include determining a network address for the wireless router to be included in a first list, determine the address for the networking device to be included in a second list, comparing the first list with the second list to determine a connective relationship between the networking device and the wireless router, and associating connection labels comprising location and time stamp with the connective relationship in the profile.

In another aspect, the usage pattern may include information relating to execution of applications on the networking device.

In another aspect, a first device and a second device that are commonly simultaneously connected to the network are associable with the profile and increase compliance of the correlation within the threshold level of confidence.

In another aspect, upon detecting a connection by the profile that is authenticated to an additional network, the system may include the additional network in the profile and update the correlation between the profile and the network.

Unless otherwise defined, all technical terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents and other references mentioned herein are incorporated by reference in their entirety. In the case of conflict, the present specification, including definitions will control.

### BRIEF DESCRIPTION OF THE DRAWINGS

FIG. 1 is a block diagram of an illustrative array of networks, according to an embodiment of the present invention.

FIG. 2 is a flowchart illustrating a detection and association of a networking device with a network at a given time and location, according to an embodiment of the present invention.

FIG. 3 is a flowchart illustrating detection of a change of location and/or time of a computerized networking device, according to an embodiment of the present invention.

FIG. 4 is a flowchart illustrating analyzing a usage pattern of a networking device, according to an embodiment of the present invention.

### DETAILED DESCRIPTION

The present invention is best understood by reference to the detailed drawings and description set forth herein. Embodiments of the invention are discussed below with reference to the drawings; however, those skilled in the art will readily appreciate that the detailed description given herein with respect to these figures is for explanatory purposes as the invention extends beyond these limited embodiments. For example, in light of the teachings of the present invention, those skilled in the art will recognize a multiplicity of alternate and suitable approaches, depending upon the needs of the particular application, to implement the functionality of any given detail described herein beyond the particular implementation choices in the following embodiments described and shown. That is, numerous modifications and variations of the invention may exist that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

The present invention should not be limited to the particular methodology, compounds, materials, manufacturing techniques, uses, and applications, described herein, as these may vary. The terminology used herein is used for the purpose of describing particular embodiments only, and is not intended to limit the scope of the present invention. As used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” may be a reference to one or more steps or means and may include sub-steps and subservient means.

All conjunctions used herein are to be understood in the most inclusive sense possible. Thus, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should be read as “and/or” unless expressly stated otherwise. Structures described herein are to be understood also to refer to functional equivalents of such structures. Language that may be construed to express approximation should be so understood unless the context clearly dictates otherwise.

Unless otherwise defined, all terms (including technical and scientific terms) are to be given their ordinary and customary meaning to a person of ordinary skill in the art, and are not to be limited to a special or customized meaning unless expressly so defined herein.

Terms and phrases used in this application, and variations thereof, especially in the appended claims, unless otherwise expressly stated, should be construed as open ended as opposed to limiting. As examples of the foregoing, the term “including” should be read to mean “including, without limitation,” “including but not limited to,” or the like; the term “having” should be interpreted as “having at least”; the term “includes” should be interpreted as “includes but is not limited to”; the term “example” is used to provide exemplary instances of the item in discussion, not an exhaustive or limiting list thereof; and use of terms like “preferably,” “preferred,” “desired,” “desirable,” or “exemplary” and words of similar meaning should not be understood as implying that certain features are critical, essential, or even important to the structure or function of the invention, but instead as merely intended to highlight alternative or additional features that may or may not be utilized in a particular embodiment of the invention.

Those skilled in the art will also understand that if a specific number of an introduced claim recitation is intended, such an intent will be explicitly recited in the claim, and in the absence of such recitation no such intent is present. For example, as an aid to understanding, the appended claims may contain usage of the introductory phrases “at least one” and “one or more” to introduce claim recitations; however, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C” is used, in general, such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.).

All numbers expressing dimensions, quantities of ingredients, reaction conditions, and so forth used in the specification are to be understood as being modified in all instances by the term “about” unless expressly stated otherwise. Accordingly, unless indicated to the contrary, the numerical parameters set forth herein are approximations that may vary depending upon the desired properties sought to be obtained.

The present invention will now be described in detail with reference to embodiments thereof as illustrated in the accompanying drawings. In the following description, a network activity association system and method will be discussed. Those of skill in the art will appreciate alternative labeling of the network activity association system and method as a networking system, network association system, network profile system, global device activity recognition system and method, wireless communication authentication system and method, system for authentication and management of wireless network communication, system, method, the invention, or other similar names. Skilled readers should not view the inclusion of any alternative labels as limiting in any way.

The network activity association system will now be discussed. The system may be operated on one or more computerized networking device that can be connected to a network. For example, the system may be operated on a server, a network connected database, or other computerized device that would be apparent to a person of skill in the art. The system may communicate with one or more other computerized networking devices via a network. In one example, the system may communicate with one or more computerized networking device via the Internet.

The system may recognize and analyze a computerized networking device attempting to connect to a network. The system may then authenticate the networking device and allow or at least partially deny access to the network. The system may identify the networking device via an address, such as a Medium Access Control (MAC) address, an Internet Protocol (IP) address, or other address. The system may associate one or more networking device with a profile, which may be used to determine a correlation between the networking device being analyzed and an authorized use of the network. The system may also compare usage activity patterns associated with the profile with a usage characteristic of a networking device to determine whether the device can be authenticated within a threshold level of confidence. Usage activity patterns may include information relating to execution of applications on the networking device.

Used throughout this disclosure, data communication is defined to include transmission and reception of data, without limitation. A wireless networking device is discussed throughout this disclosure in the context of a network connected electronic device, which may include any device capable of communicating over a wireless network. Additional wireless networking devices may include desktop computers, notebook/laptop computers, printers, smartphones, network attached storage (NAS) devices, tablets, music players, televisions, audiovisual equipment, other electronic devices, and other devices that would be apparent to a person of skill in the art. Skilled artisans will appreciate that wireless networking devices may include at least one wireless network interface controller.

Skilled artisans will appreciate that a module, as it is discussed in this disclosure, may include a group of instructions that can be executed via hardware and/or software. Modules operated by the present invention may include an association module to identify a networking device and an authentication module to authenticate a networking device. The association module may analyze a network to detect one or more identifiable networking device, which may be identified using an address. The association module may also associate an identified networking device with a profile. The authentication module may analyze a usage pattern of the profile to authenticate a user and/or connected networking device. Optimally, the authentication module may compare an instant usage pattern with a benchmark usage pattern to determine a correlation between a present usage and an expected usage.

Skilled artisans will appreciate that each of the modules discussed above may operate collectively, independently, synchronously, or in another relation with one another. Each module may control discrete instruction sets. Alternatively, the modules discussed above may be included in one uniform instruction set of the system and respectively define various operations performed by the system. Some operations may overlap. Additional modules may be included by the system. Those of skill in the art should not view this discussion of modules to limit the present invention in any way.

An illustrative computerized device will now be discussed in greater detail, without limitation. The computerized device may include a processor, memory, network controller, and optionally an input/output (I/O) controller. Skilled artisans will appreciate additional embodiments of a computerized device that may omit one or more of the aforementioned components or include additional components without limitation. The processor may receive and analyze data. The memory may store data, which may be used by the processor to perform the analysis. The memory may also receive data indicative of results from the analysis of data by the processor.

The memory may include volatile memory modules, such as random access memory (RAM), or non-volatile memory modules, such as flash based memory. Skilled artisans will appreciate the memory to additionally include storage devices, such as, for example, mechanical hard drives, solid state drives, and removable storage devices.

The computerized device may also include an I/O interface. The I/O interface may be used to transmit data between the computerized device and extended devices. Examples of extended devices may include, but should not be limited to, a display, external storage device, human interface device, printer, sound controller, or other components that would be apparent to a person of skill in the art. Additionally, one or more of the components of the computerized device may be communicatively connected to the other components via the I/O interface.

The components of the computerized device may interact with one another via a bus. Those of skill in the art will appreciate various forms of a bus that may be used to transmit data between one or more components of an electronic device, which are intended to be included within the scope of this disclosure.

The computerized device may also include a network controller, which may be a wireless network interface controller. The network controller may receive data from other components of the computerized device to be communicated with other computerized devices via a network. The communication of data may be performed wirelessly. More specifically, without limitation, the network controller may communicate and relay information from one or more components of the computerized device, or other devices and/or components connected to the computerized device, to additional connected devices. Connected devices are intended to include data servers, additional computerized devices, mobile computing devices, smart phones, tablet computers, and other electronic devices that may communicate digitally with another device.

The computerized device may communicate over the network by using its network controller. More specifically, the network controller of the computerized device may communicate with the network controllers of the connected devices. The network may be a WAN, for example, the Internet. As another example, the network may be a WLAN, which may be connected to a WAN. However, skilled artisans will appreciate additional networks to be included within the scope of this disclosure, such as intranets, local area networks, virtual private networks, peer-to-peer networks, and various other network formats. Additionally, the computerized device and/or connected devices may communicate over a network via a wired, wireless, or other connection, without limitation.

The wireless network interface controller will now be discussed. As discussed above, a wireless network interface controller is a network interface controller that communicates data wirelessly. Skilled artisans will appreciate that the term wireless network interface controller, wireless networking interface controller, wireless networking card, wireless network adapter, WLAN adapter, and other similar terms may be used interchangeably, without limitation. The network interface controller may receive data from various components of a computerized device, which it may then relay over a wireless network. Similarly, the wireless network interface controller may receive data from a wireless network connection, which it may then relay to various components of the computerized device. A network interface controller may communicate wirelessly over a WLAN.

The wireless network interface controller operates similarly to that of a traditional network interface controller, with the additional capability to communicate data wirelessly. Generally, a wireless network interface controller will include one or more radio transceivers, which may broadcast and receive radio signals over the air. A wireless network interface controller may communicate data with other devices using one or more data transmission protocols, for example, but not limited to, IEEE 802.11 Wi-Fi, token ring networks, Bluetooth, or other wireless network protocols that would be apparent to a person of skill in the art. In the interest of clarity, the present invention will be discussed in the context of the IEEE 802.11 protocols without limitation.

As will be apparent to those of skill in the art, IEEE 802.11 defines various frequency ranges at which data may be transmitted, which are segmented into channels. Various devices may communicate different packets of data using a single channel. Additionally, some channels defined by the IEEE 802.11 specification overlap with other channels. To communicate data between a transmitting wireless device and a receiving wireless device, the communication must generally be made over the same channel. To direct transmitted data to the intended recipient, an address, such as a medium access control (MAC) address, may associate the data communicated with an intended wired and/or wireless device. Alternatively, an Internet Protocol (IP) address may be assigned to one or more connected wireless networking controller to associate the data communicated with an intended wired and/or wireless device. Skilled artisans will be familiar with MAC addresses and use of the same in network communications.

Throughout this disclosure, communication of data is discussed as occurring over a wireless network. A wireless network is any type of connection between two or more electronic devices to communicate data or information without being physically attached by wires or cables. For example, a wireless network may be a WLAN established to provide communication between two or more wireless devices within a moderately short distance from a managing device, such as a wireless router. As discussed above, a WLAN may be compliant with a standard such as IEEE 802.11, communicate using a proprietary standard, and/or use another protocol that would be apparent to a skilled artisan. The WLAN may permit communication with one or more wired devices through the use of a wireless bridge, as may be proved by a wireless router. For example, a wireless device may wirelessly communicate with the wireless router, which may then relay the communication to a wired electronic device via a cable, such as an Ethernet cable.

A wireless networking device may connect to one or more wireless networks. For example, wherein the wireless networking device is a smartphone, the device may be moved between various locations including a home, an office, and a publicly provided Wi-Fi hotspot. As the smartphone is moved between these geographic locations, it may connect to different wireless networks operating in each of those locations. A person of skill in the art will appreciate additional locations at which a networking device may connect to a network.

Multiple devices may connect to a single network. As more than one user connects to the network, the source of usage activity through the network becomes difficult or impossible to differentiate among the users connected to the network for other users outside of the network. For example, multiple networking devices may be connected to a wireless router via a WLAN. One of the connected networking devices may make a request to download a file from a website, which communicates with the wireless router over a WAN. The website may not be able to differentiate which of the networking devices on the WLAN made the download request, only that the device is connected wireless router that is viewable by the website over the WAN. As some WLANs support a large number of connected networking devices, it can become nearly impossible for the website or a connected device to authenticate a source of a particular communication of data over a network using the systems and methods of the prior art.

The inability to identify the source of a communication can be particularly undesirable since virtually any user may anonymously connect to many networks without any authentication. Unauthorized users may use the network they are connected to and launch cyber-attacks to other systems over the WAN via the network. The systems targeted by the attack may only be able to discern over the WAN the wireless network from which the attack came, but not a device or user connected to the network originating the attack.

To solve the problem of unauthenticated users connecting to a network, the present invention advantageously provides a system and method to associate a networking device with a profile that can be used to identify and authenticate a user. The profile may be automatically created and populated with data relating to usage. The profile can be compared to future usage patterns and device addresses to authenticate use of a networking device. The system may intelligently analyze connectivity of devices and usage patterns to dynamically create and maintain profiles indicative of authenticated use within a threshold level of confidence. Networking devices and usage patterns associated with authenticated profiles may be permitted access to a network. Conversely, devices and usage patterns that fail to be authenticated may be at least partially denied access to a network.

For example, the system of the present invention may detect that multiple devices are typically operated by a single user, and thus are related. For example, a user may own a cell phone, a tablet, and a computer that connect wirelessly at home. The system may recognize that these devices are usually found together and associate the devices with a profile. The profile associations may then be used to authenticate the connection.

As another example, the system of the present invention may detect that multiple devices are often found together, but are operated by different users. For example, two co-workers may work in the same office and often take lunch together at a place with access to a wireless network, bringing their Wi-Fi connected smartphones. However, after the work day ends, each co-worker may return to their respective homes and separate home networks. The system may detect that the co-workers typically connect to various networks simultaneously during the work day, but connect to different networks during the evenings and nights. The system may draw a correlation that the smartphones of each co-worker are related, but not both associated with the same person. Thus, the system may assign separate profiles for each co-worker and their respective devices, but still compare each profile with one another for authentication.

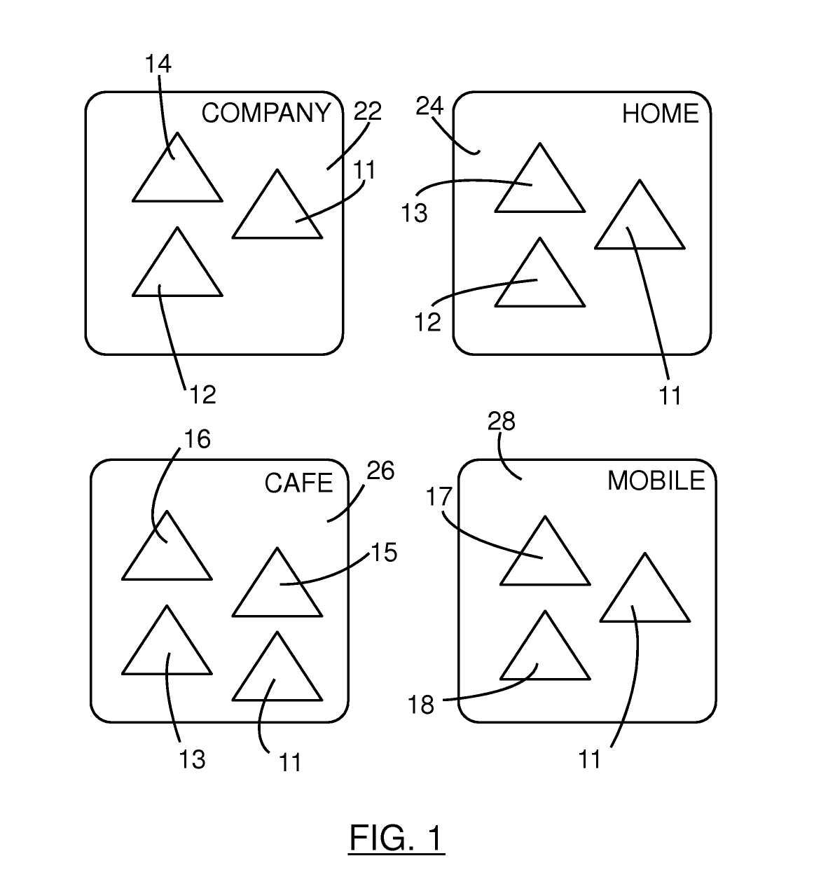

An illustrative scenario will now be described along with the block diagram of FIG. 1. In this scenario, a user of networking devices may often be located in one of four geographic locations, each with their own networks. The networks may include a company network 22, home network 24, café network 26, and mobile network 28. The mobile network may be accessible via a cellular data provider. As the user moves from location to location, the networking devices carried by the user may connect to the respective networks in each location.

A user may possess and/or operate one or more networking device, which the system may associate with a profile. For example, the user may carry a smartphone 11 that automatically connects to nearby networks. The user may also carry a laptop computer 12, which may also connect to nearby networks when operated. Other users may carry networking devices that connect to nearby networks. For example, at the company network 22, a user may connect to the network using his smartphone 11 and laptop computer 12. An additional user may connect to the company network 22 using her networking device 14. The system may recognize that the smartphone 11 and laptop computer 12 belong to the same user, and associate both networking devices with a profile. The system may also recognize that the networking device 14 is operated by a different user, and associate that networking device 14 with a different profile. Those of skill in the art will appreciate that many users and networking devices may connect to a network, which can be associated with a number of profiles, without limitation.

The profile may include correlations between networking devices and/or networks of geographic areas to help authenticate a connection by a networking device to a network. For example, the profile may include a correlation between the smartphone 11 and laptop computer 12 being connected the same network. As another example, the profile may include a correlation between the smartphone 11 being connected to one or more other known networks, such as the home network 24 or mobile network 28, prior to connecting to a company network 22. These correlations may be associated with the profile, which may be stored remotely on a database. The profile may be accessed from any connected network. In one example, the profile may be accessed from the database through any network capable of connecting to the database, such as through a WAN.

A profile may associate the connection of a networking device at various geographic locations. Similarly, a number of networking devices may be connected to a network at each geographic location. Skilled artisans will appreciate that multiple networks may operate at approximately the same geographic location, one or more of which may be associated with the profile.

As illustrated in FIG. 1, four networks are provided in the example scenario. Skilled artisans will appreciate that four networks are discussed in the interest of clarity and additional networks are associable with additional profiles. In this example, a user typically operates two networking devices, a smartphone 11 and a laptop computer 12. Also, in this example, the user typically connects to the four networks, including a company network 22, a home network, 24, a café network 26, and a mobile network 28. A profile may be associated with the user to authenticate one or more of the networking devices connecting to the networks.

To associate multiple networking devices with the same profile, the system may monitor connections made to the networks over a period of time. If the same devices typically and commonly connect to networks at approximately the same time, the system may associate both networking devices to the same profile. The system may also update and maintain the devices and networks associated with the profile, which may allow correlations between networks, devices, and users to be added, modified, and/or removed.

The profile may associate the networking device with networks of a geographic location and provide access to the association over a WAN via other networks. When a connection is detected that is indicative of a profile, the system may draw correlations between attempted connection by the networking device and the profile for authentication. The connection may be detected, for example, by analyzing an address for the networking device, such as the MAC address.

The example user may use a laptop computer 12 at both his company and home. The user may also carry a smartphone 11 with him at the company, at home, and when he visits the café. Each of these geographic locations may have respective networks 22, 24, 26 to which the user can connect one or more of his network devices 11, 12. The smartphone 11 may also operate over a mobile network 28 while outside these geographic locations.

The system may recognize that the user typically connects to the home network 24 using both the smartphone 11 and laptop computer 12. When both networking devices 11, 12 are connected to the home network 24, a correlation may be drawn. This correlation may be analyzed for compliance with an expected condition of an associated profile within a threshold level of confidence to authenticate the devices. The expected condition may relate to a benchmark usage pattern for the profile. The system may also determine that networking device 13 is typically also connected to the home network 24. The presence of networking device 13 on the home network 24 may correlate with an expected condition for the home network 24, even though networking device 13 might not be associated with the profile. For example, networking device 13 may be a smartphone operated by the user's spouse.

Similarly, the user may connect to the company network 22 using both the smartphone 11 and laptop computer 12. When both networking devices 11, 12 are connected to the company network 22, a correlation may also be drawn. Like with the home network 24, this correlation may be analyzed for compliance with an expected condition of an associated profile within a threshold level of confidence to authenticate the devices. As with the analysis for the home network 24, the expected condition may relate to a benchmark usage pattern for the profile. The system may also determine that networking device 14 is typically also connected to the company network 22. The presence of networking device 14 on the company network 22 may correlate with an expected condition for the company network 22, even though networking device 14 might not be associated with the profile.

The user may frequently visit a café. The user may typically bring his smartphone 11 to the café and to connect to the café network 26 via the smartphone 11. The system may detect the presence of the smartphone 11 at the café and details relating to the connection of the smartphone 11 to the café network 26. For example, the system may determine that the smartphone 11 typically connects to the café network 26 approximately at lunch time and may associate the connection details with the profile. The associated connection details may be used to define a benchmark usage pattern. If the system detects an attempted connection by the smartphone 11 to the café network 26 at approximately lunch time, it may determine that a correlation exists with the expected condition of the profile and authenticate the connection.

In one illustrative scenario, the user may meet his or her spouse for lunch every day at the café. The spouse may bring his or her smartphone 13, which typically shares a connection with the user's smartphone 11 on the home network 22, to meet the user at the café. Both the user and spouse may connect to the café network 26 with their respective smartphones 11, 13. The system may detect the connection and determine that both devices are associated with different people and thus different profiles. This determination may be guided by different connection scenarios throughout the rest of the day, without limitation. Since the profiles are related, the system may correlate the connection of the user and spouse smartphones 11, 13, and their respective profiles, for authentication. Other networking devices that are not associated with the profile may also connect to the café network 26, such as networking devices 15 and 16.

In another example, a connection by a networking device may be associated with a mobile network 28, such as a network connection provided by a cellular data service. The mobile network 28 may provide network access to a smartphone 11 or other networking device. The system may determine when a networking device, such as the smartphone 11, attempts to connect to the mobile network 28 after leaving a geographic area associated with another authorized network, such as the company network 22. Other networking devices that are not associated with the profile may also connect to the mobile network 28, such as networking devices 17 and 18.

As an example, the system may be used to authenticate a smartphone 11 on various networks according to the following scenario, without limitation. The smartphone may be connected to a company network 22 and authenticated. A user may then leave for lunch at the café, taking his smartphone 11. Upon exiting the range of the company network 22, but still near the geographic location of the company, the smartphone may attempt to switch from the company network 22 to the mobile network 28. The system may then compare the address of the networking device and attempted network connection with the profile to authenticate the connection.

To authenticate the connection, the system may look for correlations between the attempted network connection and expected conditions of the benchmark usage pattern in the profile. If a correlation is made between the attempted connection and the profile within a threshold level of confidence, the connection may be authenticated. Here, the system may determine that the MAC address of the smartphone 11 correlates with a MAC address included by the profile. The system may also determine that connecting to the mobile network 28 near the geographic location of the company network 22 correlates with usage characteristics included by the profile. The system may analyze the correlations between the attempted connection and the profile to determine whether the attempted connection is correlated within a threshold level of confidence. If the correlation between the attempted connection and the profile is within the threshold level of confidence, the connection may be authenticated. If the correlation is not within the threshold level of confidence, the connection may fail to be authenticated and the connection may be at least partially denied.

The profile may include connection detail and expected conditions that can be used to authenticate a connection between the networking device and a network. The profile may be stored in a database, which may be connected to multiple networks via a WAN, such as the Internet. The profile may include information such as addresses for hardware devices, commonly connected networks, other devices that may frequently connect a network, geographic locations, times and durations of connections, application usage patterns, and other benchmark usage patterns and expected conditions that may be used to authenticate a connection.

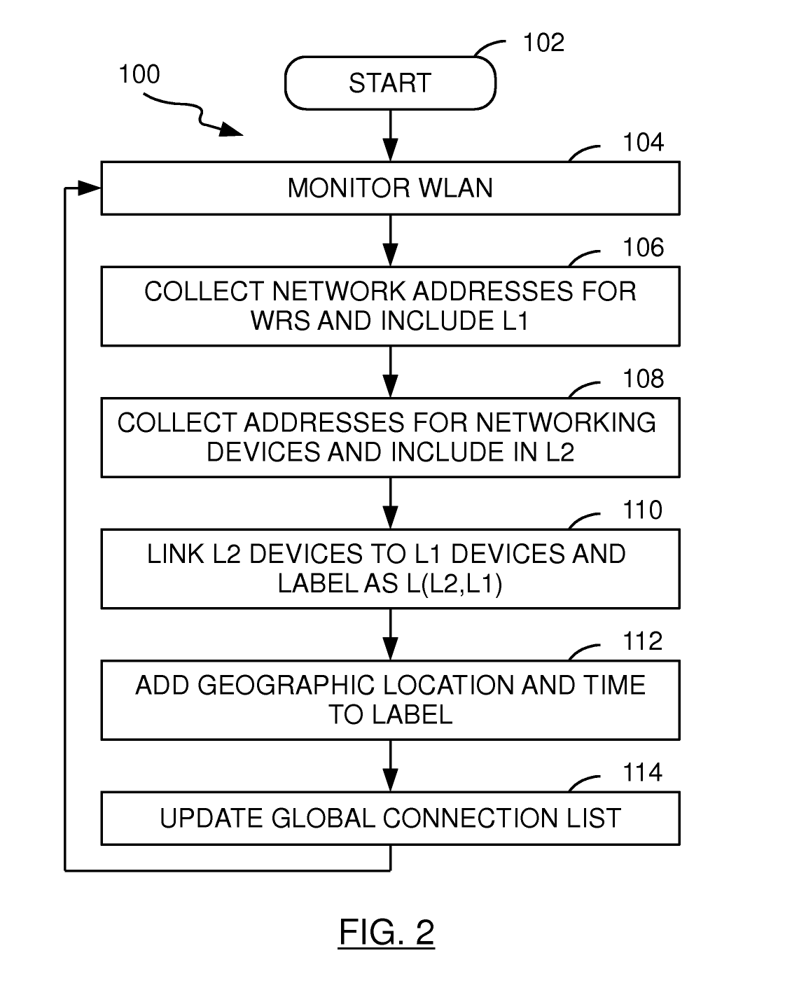

In operation, a method may be operated by the system to authenticate a networking device attempting to connect to a network. Referring now to flowchart 100 of FIG. 2, an illustrative method of associating a networking device with a network will now be discussed. Starting at Block 102, the system monitors a wireless local area network (WLAN) for attempted connections. (Block 104). The system may also detect global data, such as geographic location, date, and time, which may be associated with the attempted connection. The system may then collect connection details related to a wireless router providing the WLAN, such as a network address, which may be included in a first list L1. (Block 106). The network address may be a MAC address. The system may also collect connection details related to networking devices connected to the WLAN, such as an address, which may be included in a second list L2. (Block 108). The address collected from the networking device may also be a MAC address. Once both lists have been filled, the system may link L2 devices to L1 devices, associating a label L(L2,L1) to each detected networking device. (Block 110).

If a networking device is detected that is not connected to a WLAN or wireless router, a label may be associated using a notation such as L(L2,0), wherein the 0 number represents a lack of connection to a wireless receiver. Global data, for example geographic location and time stamp, may then be associated with each label. (Block 112). A resulting label may include a notation such as L(L2,L1,location,time). Geographic location may be included in the label as a longitude/latitude value and/or an Internet Protocol (IP) address. The label may then be included in a global list remotely accessible by other networks and system agents. (Block 114). The global list may be included in a database and may be addressable via a file system, without limitation. Once the global list has been updated at Block 114, the operation may return to Block 104, where the system may again monitor the WLAN. This method advantageously permits the globalization of local addresses for networking devices by binding the address to a globally understood identifier, such as a profile.

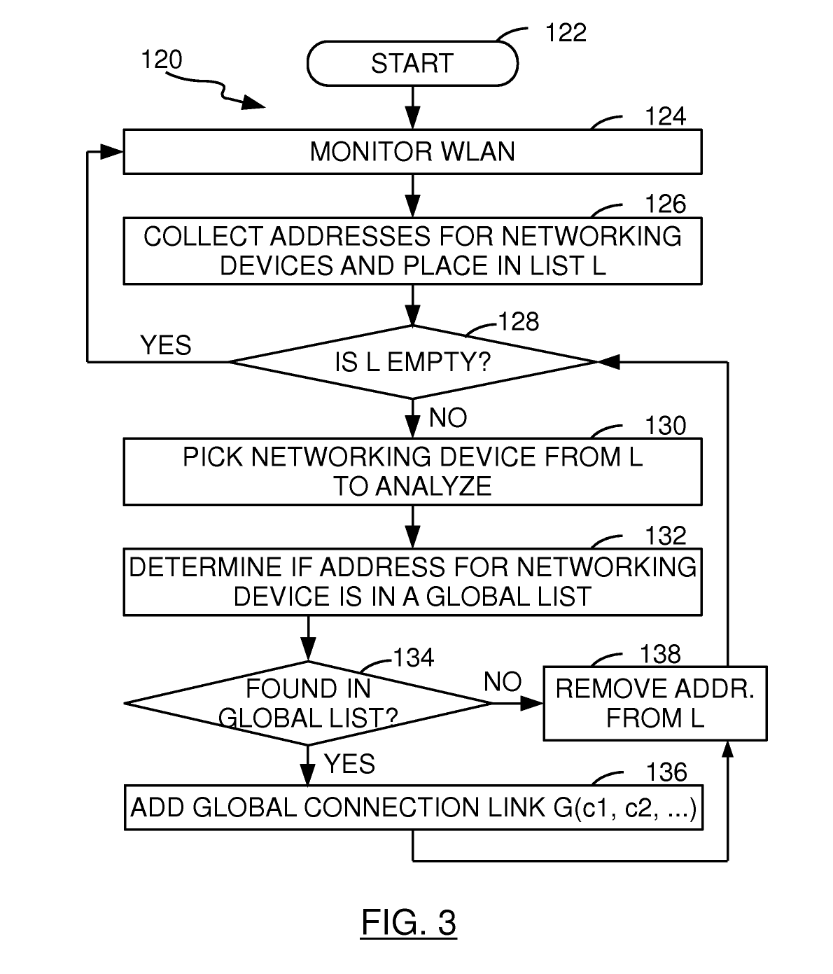

Referring now to flowchart 120 of FIG. 3, an illustrative method for discovering and updating a location of a networking device in a profile will now be discussed. Starting at Block 122, the system may monitor the WLAN for connected networking devices. (Block 124). The system may then collect addresses that identify the connected networking devices, for example MAC addresses. (Block 126). The collected addresses may be placed in a list L. The system may then determine at Block 128 whether the list L is empty. If it is determined at Block 128 that the list L is empty, the operation will return to Block 124 and again monitor the WLAN.

If it is determined at Block 128 that list L is not empty, the system may pick a networking device from list L to analyze. (Block 130). The system may determine whether the networking device exists in a global connection list, for example, as a profile included in a remote database. (Block 132). An entry in the global connection list may have been established using the method of flowchart 100, as discussed above.

The system may determine whether a match between the networking device and the global list is found. (Block 134). If a match is not found at Block 134, the system may remove the address of the networking device from list L. (Block 138). If a match is found at Block 134, the system may add a new connection record to the entry for networking device in the global list. (Block 136). The global connection link may be stored using a notation such as G(c1,c2, . . . ), wherein c1 and c2 are connections. The various entries of the global list for a particular networking device may be combined to create a profile. The profile may be used to track activity for the networking device across multiple networks, recording information such as connection time, location, and other details. After the global connection link has been added to the profile, the system may remove the address of the networking device from list L. (Block 138).

After an address is removed from list L at Block 138, the operation may return to Block 128 and again determine whether list L is empty. If addresses remain in list L for other networking devices, the system may continue to loop through steps 130-138 and determine whether the additional networking devices are included in a global list. After all networking devices have been analyzed, list L will be empty and will cause the logic check at Block 128 to direct the operation to again monitor the WLAN for new connections, as provided by Block 124.

A networking device may be authenticated by analyzing usage activity that can be compared to an expected condition in a profile. To evaluate application and usage activity, an entropy formula may be used. The entropy may calculate a percentage and/or frequency of usage for applications operated on a networking device. Each application may be designated by an indicator, such as a number, that may represent the percentage of its usage compared to other applications operated on the networking device.

An entropy calculation may be performed to compare presently observed entropies with previous observations from the same networking device, which may be included as part of a benchmark usage pattern in the profile associated with the networking device. If the usage characteristics approximately match or correlate with the benchmark usage pattern, within a definable margin of error, usage activity may be determined as normal. Conversely, if it is determined that the usage characteristics differ significantly from the previously observed entropies, access to the network may be at least partially denied and/or an alert may be generated. An alert may include an audible alarm, visual display, email message, electronic communication, flag being set in the profile or in the database, or other technique to draw attention to an activity. By analyzing usage characteristics along with an address of a networking device, the system may increase the accuracy of identifying a networking device and determine a correlation between a profile and a networking device for authentication with a high level of confidence.

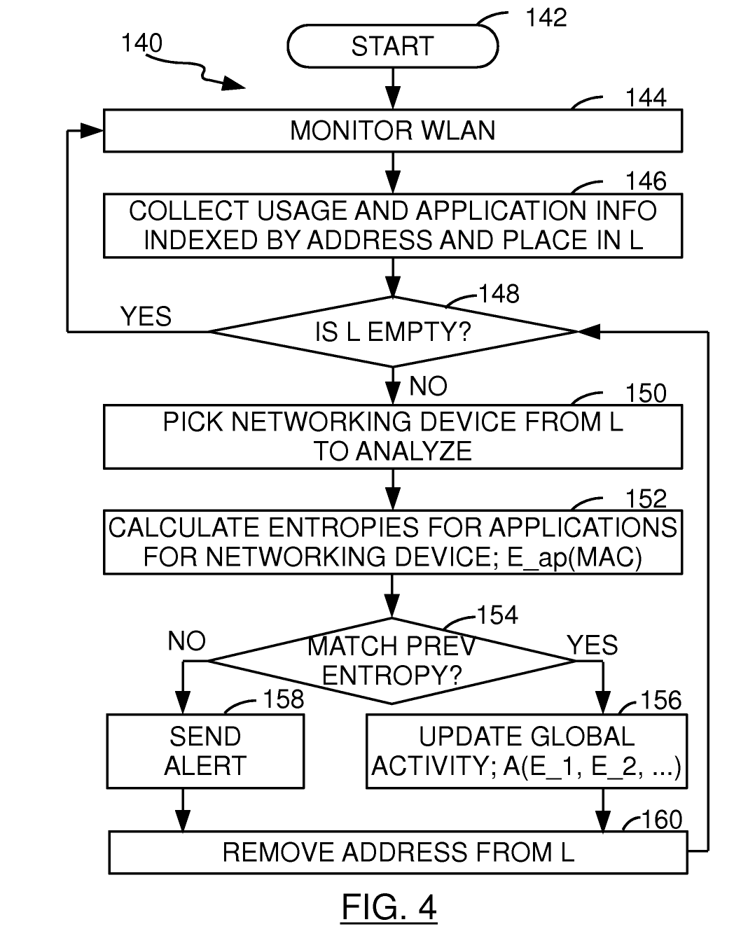

Referring now to flowchart 140 of FIG. 4, a method for monitoring application and usage activity will now be discussed. Starting at Block 142, the system may monitor the WLAN for networking devices. (Block 144). The system may collect user information relating to usage and application activity, which may be indexed by an address of the networking device. (Block 146). The information may be used to determine a benchmark usage pattern. The collected information, including the addresses of the networking devices, may be placed in a list L. The system may then determine at Block 148 whether the list L is empty. If it is determined at Block 148 that the list L is empty, the operation will return to Block 144 and again monitor the WLAN.

If it is determined at Block 148 that list L is not empty, the system may pick a networking device from list L to analyze. (Block 150). The system may calculate entropies for a specific application executed by the networking device, which may be labeled as E_ap(MAC). (Block 152). For this label, “E” may indicate that the label relates to calculated entropy, “ap” may be representative of the application being analyzed, and “MAC” may indicate the MAC address of the networking device being analyzed.

The system may determine whether a match exists between the present entropy of the networking device and previous or benchmark entropy included in the profile. (Block 154). If a match is found at Block 154, the system may update the global activity record to reflect the matching entropy. (Block 156). The global activity may be stored using a notation such as A(E_{—}1, E_{—}2, . . . ), wherein E_{—}1 and E_{—}2 are entropies. After the global activity list has been updated, the system may move to Block 160 and remove the address of the networking device from list L. If a match is not found at Block 154, the system may send an alert. (Block 158). As discussed above, an alert may include an audible alarm, visual display, email message, electronic communication, flag being set in the profile or in the database, or other technique to draw attention to an activity. After the alert has been sent, the system may move to Block 160 and remove the address of the networking device from list L.

After the address is removed from list L at Block 160, the operation may return to Block 148 and again determine whether list L is empty. If addresses remain in list L for other networking devices, the system may continue to loop through steps 150-160 and determine whether the additional networking devices are included in the global activity list. After all networking devices have been analyzed, list L will be empty and will cause the logic check at Block 148 to direct operation to again monitor the WLAN for new connections, as provided by Block 144.

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. A network activity association method operated on a computerized device with a processor and memory comprising:
(a) analyzing a network to detect an identifiable networking device;
(b) identifying the networking device using an address;
(c) associating the networking device with a profile;
(d) analyzing a usage pattern of communicating over the network for the profile to maintain a benchmark usage pattern;
(e) analyzing a subsequent usage pattern of communicating over the network for the profile;
(f) comparing the subsequent usage pattern with the benchmark usage pattern to determine a correlation;
(g) authenticating the profile with the correlation within a threshold level of confidence; and
(h) allowing access to the network for the profile that is authenticated and at least partially denying access to the network for the profile that fails to be authenticated;
wherein the profile is indicative of a user;
wherein the benchmark usage pattern is updatable;
wherein a plurality of networking devices is associable with the profile;
wherein the profile is storable in a database accessible from the network;
wherein the profile is accessible from the database over a plurality of networks.

2. The method of claim 1, wherein the address is a medium access control (MAC) address.

3. The method of claim 1, wherein the network is associable with a wireless router.

4. The method of claim 3, wherein step (c) further comprises:
(i) determining a network address for the wireless router to be included in a first list;
(j) determine the address for the networking device to be included in a second list;
(k) comparing the first list with the second list to determine a connective relationship between the networking device and the wireless router; and
(l) associating connection labels comprising location and time with the connective relationship in the profile.

5. The method of claim 1, wherein the usage pattern includes information relating to execution of applications on the networking device.

6. The method of claim 1, wherein a first device and a second device that are commonly simultaneously connected to the network are associable with the profile and increase compliance of the correlation within the threshold level of confidence.

7. The method of claim 1, wherein upon detecting a connection to the network by the profile that is authenticated for an additional network, the system includes the additional network in the profile and updates the correlation between the profile and the network.

8. The method of claim 1, wherein the method further comprises generating an alert for the profile that fails to be authenticated.

9. A network activity association method operated on a computerized device with a processor and memory comprising:
(a) analyzing a network associable with a wireless router to detect an identifiable networking device;
(b) identifying the networking device using an address;
(c) associating the networking device with a profile, further comprising:
(i) determining a network address for the wireless router to be included in a first list,
(ii) determining the address for the networking device to be included in a second list,
(iii) comparing the first list with the second list to determine a connective relationship between the networking device and the wireless router, and
(iv) associating connection labels comprising location and time with the connective relationship in the profile.
(d) analyzing a usage pattern of communicating over the network for the profile to maintain a benchmark usage pattern;
(e) analyzing a subsequent usage pattern of communicating over the network for the profile;
(f) comparing the subsequent usage pattern with the benchmark usage pattern to determine a correlation;
(g) authenticating the profile with the correlation within a threshold level of confidence; and
(h) allowing access to the network for the profile that is authenticated and at least partially denying access to the network for the profile that fails to be authenticated, an alert being generable for the profile that fails to be authenticated;
wherein the profile is indicative of a user;
wherein the benchmark usage pattern is updatable;
wherein a plurality of networking devices is associable with the profile.

10. The method of claim 9, wherein the address is a medium access control (MAC) address.

11. The method of claim 9, wherein the profile is storable in a database accessible from the network and wherein the profile is accessible from the database over a plurality of networks.

12. The method of claim 9, wherein the usage pattern includes information relating to execution of applications on the networking device.

13. The method of claim 9, wherein a first device and a second device that are commonly simultaneously connected to the network are associable with the profile and increase compliance of the correlation within the threshold level of confidence.

14. The method of claim 9, wherein upon detecting a connection by the profile that is authenticated to an additional network, the system includes the additional network in the profile and updates the correlation between the profile and the network.

15. A network activity association system comprising:
an association module to detect an identifiable networking device by performing the steps:
(a) analyzing a network to detect the identifiable networking device,
(b) identifying the networking device using an address, and
(c) associating the networking device with a profile; and an authentication module to authenticate the profile by performing the steps:
(d) analyzing a usage pattern of communicating over the network for the profile to maintain a benchmark usage pattern,
(e) analyzing a subsequent usage pattern of communicating over the network for the profile,
(f) comparing the subsequent usage pattern with the benchmark usage pattern to determine a correlation,
(g) authenticating the profile with the correlation within a threshold level of confidence, and
(h) allowing access to the network for the profile that is authenticated and at least partially denying access to the network for the profile that fails to be authenticated,
wherein an alert is generable for the profile that fails to be authenticated;
wherein the profile is indicative of a user;
wherein the benchmark usage pattern is updatable;
wherein a plurality of networking devices are associable with the profile;
wherein the profile is storable in a database accessible from the network;
wherein the profile is accessible from the database over a plurality of networks;
wherein the network is associable with a wireless router.

16. The system of claim 15, wherein the address is a medium access control (MAC) address.

17. The system of claim 15, wherein step (c) further comprises:
(i) determining a network address for the wireless router to be included in a first list;
(j) determine the address for the networking device to be included in a second list;
(k) comparing the first list with the second list to determine a connective relationship between the networking device and the wireless router; and
(l) associating connection labels comprising location and time with the connective relationship in the profile.

18. The system of claim 15, wherein the usage pattern includes information relating to execution of applications on the networking device.

19. The system of claim 15, wherein a first device and a second device that are commonly simultaneously connected to the network are associable with the profile and increase compliance of the correlation within the threshold level of confidence.

20. The system of claim 15, wherein upon detecting a connection by the profile that is authenticated to an additional network, the system includes the additional network in the profile and updates the correlation between the profile and the network.
